(19) United States
(12) Patent Application Publication
(10) Pub. No.: US 2025/0042065 A1
(43) Pub. Date: Feb. 6, 2025

(54) MOLDED RIGID POLYMER ARTICLE AND MOLDED RIGID POLYMER ARTICLE PRODUCTION METHOD

(71) Applicant: OSAKA UNIVERSITY, Osaka (JP)

(72) Inventors: Masaya NOGI, Suita-shi (JP); Takaaki KASUGA, Suita-shi (JP)

(73) Assignee: OSAKA UNIVERSITY, Osaka (JP)

(21) Appl. No.: 18/694,728

(22) PCT Filed: Sep. 21, 2022
(86) PCT No.: PCT/JP2022/035079

§ 371 Date: Oct. 7, 2024

(30) Foreign Application Priority Data
Sep. 22, 2021 (JP) 2021-154644

(51) Int. Cl. B29C 41/02; B29C 41/42; B29L 31/00

(52) U.S. Cl. CPC B29C 41/02; B29C 41/42; B29L 2031/7544

(57) ABSTRACT

A molded rigid polymer article production method includes forming a molded rigid polymer article from a rigid-polymer-dispersed liquid and drying the molded rigid polymer article. The rigid-polymer-dispersed liquid contains a polar medium and rigid polymers dispersed in the polar medium. The molded rigid polymer article is derived from the rigid polymers deposited on at least one of first and second electrodes. In the forming, the at least one includes a surface on which the rigid polymers are deposited, and convex or concave portions at the surface. The convex or concave portions are larger than a thickness of the molded rigid polymer article.

### TECHNICAL FIELD

The present invention relates to a molded rigid polymer article and a molded rigid polymer article production method.

### BACKGROUND ART

It is known that molded nanofiber articles are formed from a nanofiber-dispersed liquid in which nanofibers are dispersed in a solvent. Molded nanofiber articles are being considered for use as an alternative to paper phenolic boards. Molded nanofiber articles are also being considered for use as disposable protective plates because they are biodegradable materials. Molded cellulose nanofiber articles are further being considered for use as a packing in oil because cellulose nanofibers have extremely high oil resistance (see Patent Literature 1).

Patent Literature 1 describes a process for producing molded microfibrillated-cellulose articles from a microfibrillated-cellulose nanofiber suspension in which microfibrillated-cellulose is dispersed. In a production method of Patent Literature 1, a microfibrillated-cellulose suspension is prepared. The microfibrillated-cellulose suspension is obtained by dispersing microfibrillated-cellulose in water, an organic solvent, or a mixed solvent of water and an organic solvent. The microfibrillated-cellulose suspension is subjected to pre-dehydrating and thermoforming using heat and pressure while being sealed, thereby forming molded microfibrillated-cellulose articles.

### CITATION LIST

### Patent Literature

Patent Literature 1 JP 2018-100466 A

### SUMMARY OF INVENTION

### Technical Problem

In the production method described in Patent Literature 1, molded nanofiber articles may not be easily formed into a desired shape.

The present invention has been achieved in view of the above circumstances, and an object thereof is to provide a molded rigid polymer article and a molded rigid polymer article production method, enabling the molded rigid polymer article to be easily formed into a desired shape.

### Solution to Problem

A molded rigid polymer article production method according to an aspect of the present invention includes forming a molded rigid polymer article from a rigid-polymer-dispersed liquid and drying the molded rigid polymer article. The rigid-polymer-dispersed liquid contains a polar medium and rigid polymers dispersed in the polar medium. The molded rigid polymer article is derived from the rigid polymers deposited on at least one of first and second electrodes. In the forming, the at least one includes a surface on which the rigid polymers are deposited, and convex or concave portions at the surface. The convex or concave portions are larger than a thickness of the molded rigid polymer article.

In an embodiment, in the forming, the rigid polymers include a polysaccharide with a straight chain of main chain structure.

In an embodiment, in the forming, field strength at the at least one is 500 V/cm or less.

In an embodiment, in the forming, the at least one includes an insulating base and a conductive film covering a surface of the insulating base.

In an embodiment, the molded rigid polymer article production method further includes dissolving the base.

In an embodiment, the forming includes dissolving the insulating base.

A molded rigid polymer article according to an aspect of the present invention includes a first principal surface, a second principal surface, and a lateral that connects the first and second principal surfaces. One of the first and second principal surfaces includes a convex portion greater than a height of the lateral, while another of the first and second principal surfaces includes a concave portion greater than the height of the lateral.

In an embodiment, the rigid polymers include a polysaccharide with a straight chain of main chain structure.

In an embodiment, the molded rigid polymer article has a degree of orientation that is 20% or more.

In an embodiment, the rigid polymers include bio-nanofibers or rigid main chain structures.

### Advantageous Effects of Invention

In the present invention, a molded rigid polymer article can be easily formed into a desired shape.

### BRIEF DESCRIPTION OF DRAWINGS

FIG. 1 is a schematic diagram of a production device for producing a molded rigid polymer article according to the present embodiment.

FIG. 2 is a flow chart that depicts a molded rigid polymer article production method according to the present embodiment.

FIG. 3 is a schematic diagram of a production device for producing a molded rigid polymer article according to the present embodiment.

FIGS. 4A to 4C schematically illustrate a molded rigid polymer article production method according to the present embodiment.

FIG. 5 is a schematic diagram of a production device for producing a molded rigid polymer article according to the present embodiment.

FIGS. 6A to 6C schematically illustrate a molded rigid polymer article production method according to the present embodiment.

FIG. 7A is a schematic diagram of a molded rigid polymer article produced by applying voltage at a relatively low field strength, FIG. 7B is a schematic diagram that depicts the orientation of the molded rigid polymer article in FIG. 7A, and FIG. 7C is a schematic diagram of a molded rigid polymer article derived from the molded rigid polymer article of FIG. 7A that has been dried.

FIG. 8A is a schematic diagram of a molded rigid polymer article deposited by applying voltage at a moderate field strength, FIG. 8B is a schematic diagram that depicts the orientation of the molded rigid polymer article in FIG. 8A, and FIG. 8C is a schematic diagram of a molded rigid polymer article derived from the molded rigid polymer article of FIG. 8A that has been dried.

FIG. 9A is a schematic diagram of a molded rigid polymer article produced by applying voltage at a relatively high field strength, FIG. 9B is a schematic diagram that depicts the orientation of the molded rigid polymer article in FIG. 9A, and FIG. 9C is a schematic diagram of a molded rigid polymer article derived from the molded rigid polymer article of FIG. 9A that has been dried.

FIG. 10A is a schematic diagram of a molded rigid polymer article according to the present embodiment and FIG. 10B schematically illustrates that the molded rigid polymer article in FIG. 10A is used for microneedles.

FIG. 11 is a schematic perspective view of an electrode in a production device for producing a molded rigid polymer article according to the present embodiment.

FIG. 12 is a flow chart that depicts a molded rigid polymer article production method according to the present embodiment.

FIG. 13A is a schematic diagram of a molded rigid polymer article according to the present embodiment and FIG. 13B is a schematic diagram of a molded rigid polymer article derived from the molded rigid polymer article of FIG. 13A that has been dried.

FIG. 14A is a schematic diagram of an electrode in a production device for producing a molded rigid polymer article according to the present embodiment and FIG. 14B is a schematic exploded view of the electrode of FIG. 14A.

FIG. 15 a flow chart that depicts a molded rigid polymer article production method according to the present embodiment.

FIG. 16A is a schematic perspective view of an electrode in a production device for producing a molded rigid polymer article according to the present embodiment, FIG. 16B is a schematic diagram of a molded aerogel nanofiber article produced on the electrode of FIG. 16A, and FIG. 16C is a schematic diagram that depicts an internal structure of the molded aerogel nanofiber article of FIG. 16B.

FIG. 17 is a flow chart that depicts a molded rigid polymer article production method according to the present embodiment.

FIG. 18A is a schematic perspective view of an electrode in a production device for producing a molded rigid polymer article according to the present embodiment, FIG. 18B is a schematic diagram of a molded hydrogel nanofiber article deposited on the electrode of FIG. 18A, and FIG. 18C is a schematic diagram of a molded aerogel nanofiber article produced by drying the molded hydrogel nanofiber article of FIG. 18B.

FIGS. 19A to 19D illustrate a molded cellulose nanofiber article production method in the present example.

FIG. 20A illustrates a molded cellulose nanofiber article produced by applying a voltage of 1V in the present example, FIG. 20B illustrates a microscopic image of the molded cellulose nanofiber article of FIG. 20A photographed, FIG. 20C illustrates a molded cellulose nanofiber article produced by applying a voltage of 5V in the present example, FIG. 20D illustrates a microscopic image of the molded cellulose nanofiber article of FIG. 20C photographed, FIG. 20E illustrates a molded cellulose nanofiber article produced by applying a voltage of 30V in the present example, and FIG. 20F illustrates a microscopic image of the molded cellulose nanofiber article of FIG. 20E photographed.

FIG. 21A illustrates a molded cellulose nanofiber article immediately after being produced by a production method of the present example and FIG. 21B illustrates a molded cellulose nanofiber article after drying.

FIG. 22A illustrates an electrode used in the production of a molded nanofiber article of the present example, FIG. 22B illustrates a molded hydrogel cellulose nanofiber article formed in the present example, and FIG. 22C illustrates a molded aerogel nanofiber article in the present example.

### DESCRIPTION OF EMBODIMENTS

Embodiments of a molded rigid polymer article and a molded rigid polymer article production method of the present invention will now be described below. The present invention is however not limited to the embodiments below. The present invention may be implemented in various manners within a scope not departing from the essence thereof. Note that duplicate descriptions may be omitted as appropriate.

### First Embodiment

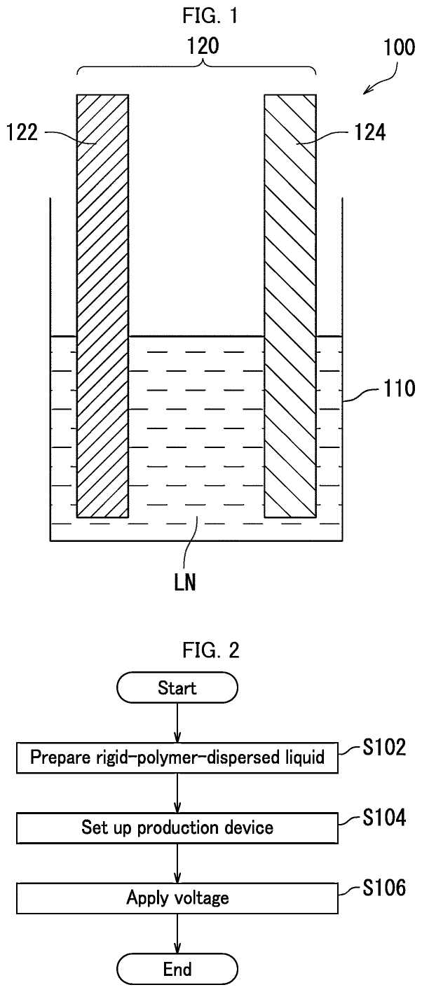

A molded rigid polymer article and a molded rigid polymer article production method according to the present embodiment will now be described with reference to FIGS. 1 to 9C. FIG. 1 is a schematic diagram of a production device 100 for producing the molded rigid polymer article according to the present embodiment.

As depicted in FIG. 1, the production device 100 includes a vessel 110 and electrodes 120. The electrodes 120 includes an electrode 122 and an electrode 124. At least part of the electrodes 122 and 124 is placed within the vessel 110.

The vessel 110 holds a rigid-polymer-dispersed liquid LN. The rigid-polymer-dispersed liquid LN may be prepared by dispersing rigid polymers in a polar medium. For example, the rigid-polymer-dispersed liquid LN is a nanofiber-dispersed liquid. The nanofiber-dispersed liquid may be prepared by dispersing nanofibers in a polar medium.

Typically, the rigid-polymer-dispersed liquid is a suspension. The polar medium is, for example water. The rigid-polymer-dispersed liquid LN is prepared by mixing the polar medium and the rigid polymers. Note that in the present specification, the rigid-polymer-dispersed liquid LN may be simply described as a dispersion liquid LN.

The electrodes 122 and 124 as a pair of electrodes are immersed in the dispersion liquid LN. DC voltage is then applied across the electrodes 122 and 124 for a predetermined time. Rigid polymers (not depicted in FIG. 1) are deposited on a surface of at least one of the electrodes 122 and 124 according to a corresponding surface shape of the electrodes. During application of the DC voltage, one of the electrodes 122 and 124 is an anode, while the other of the electrodes 122 and 124 is a cathode. Assumed that rigid polymers to be used are negatively charged in the polar medium. In this case, rigid polymers are deposited on a surface of the anode by the application of the DC voltage. On the other hand, assumed that rigid polymers to be used are positively charged in the polar medium. In this case, rigid polymers are deposited on a surface of the cathode by the application of the DC voltage.

### [Rigid Polymer]

Rigid polymers are polymers with a rigid main chain structure. Typically, the rigid polymers are nanofibers. The rigid polymers are however not limited to nanofibers.

### [Nanofiber]

Nanofibers are fibrous materials with fiber diameters in the nanometer range. The average fiber diameter of the nanofibers is 1 nm or more and 500 nm or less. The average fiber diameter of the nanofibers may be 1 nm or more and 400 nm or less, or 1 nm or more and 350 nm or less. Typically, the length of the nanofibers is at least 100 times the fiber diameter.

The nanofibers may be bio-nanofibers. Bio-nanofibers are biopolymers. Alternatively, the nanofibers may be synthesized polymers.

The nanofibers may be cellulose nanofibers, chitin nanofibers, chitosan nanofibers, or mixtures thereof.

For example, cellulose nanofibers may be produced by bleaching and defibering wood chips to form pulp fibers and then further defibering. Examples of raw materials for cellulose nanofibers include conifer bleached kraft pulp, hardwood pulp, cotton pulp (specifically, cotton linter), wheat straw pulp, and bagasse pulp.

Note that the rigid polymers in the present embodiment may be other than bio-nanofibers. Typically, polymers with a rigid main chain structure exhibit liquid crystalline and flow birefringence. In the case where a concentrated aqueous solution with a certain concentration or more is prepared, the rigid polymers are in a liquid crystalline state in the solution. When an aqueous solution containing rigid polymers is allowed to flow, the polymers are oriented in their flow directions and exhibit liquid crystalline properties (flow birefringence). Preferably, rigid polymers exhibit liquid crystalline or flow birefringence at an aqueous solution concentration of 2% by weight or more, for example.

Typically, polymers employed as the rigid polymers in the present embodiment include, for example polysaccharides with a rigid main chain structure. The polysaccharides may include a straight chain of main chain structure. Examples of the rigid polymers in the present embodiment include carboxymethyl cellulose, alginic acid, hyaluronic acid, chondroitin sulfate, carrageenan, and xanthan gum. When these types of rigid polymers are produced, the rigid polymers are deposited on the surface of the anode by application of DC voltage.

### [Polar Medium]

Examples of polar medium include water, polar organic solvents, and mixtures thereof. Examples of the polar organic solvents include methanol, ethanol, 2-propanol, acetone, dimethyl sulfoxide, ethylene glycol, acetonitrile, dioxane, and dimethylformamide. As the polar medium, water is preferred and distilled water is more preferred in order to obtain a rigid-polymer-dispersed liquid containing a higher concentration of rigid polymers while further reducing production costs.

### [Rigid-Polymer-Dispersed Liquid LN]

A rigid-polymer-dispersed liquid LN is prepared by adding rigid polymers to a polar medium. The rigid-polymer-dispersed liquid LN contains rigid polymer at a content ratio of 0.01 mass % or more and 5 mass % or less. Typically, the rigid-polymer-dispersed liquid LN is 0.80 mS/m or more and 35.00 mS/m or less in electrical conductivity (specific electrical conductance). The specific electrical conductance may be 0.80 mS/m or more and 30.00 mS/m or less, 0.80 mS/m or more and 20.00 mS/m or less, or 0.83 mS/m or more and 15.00 mS/m or less.

### [Vessel 110]

A vessel 110 holds a rigid-polymer-dispersed liquid LN. Examples of the vessel 110 include beakers.

### [Electrode 120]

Electrodes 120 are placed within a vessel 110. The electrodes 120 include electrodes 122 and 124. Examples of the electrodes 122 and 124 include carbon electrodes, gold electrodes, platinum electrodes, silver electrodes, copper electrodes, and iron electrodes. The electrodes 122 and 124 may be made of the same type of material as each other or of different types of material from each other. The electrodes 122 and 124 are preferably a pair of carbon electrodes, a pair of gold electrodes, or a pair of platinum electrodes, and more preferably a pair of carbon electrodes in order to suppress dissolution of the electrodes 122 and 124 when rigid polymers are deposited.

The distance between the electrodes 122 and 124 may be 0.1 mm or more and 5,000 mm or less, 1 mm or more and 500 mm or less, or 10 mm or more and 50 mm or less in order to obtain a molded rigid polymer article containing a higher concentration of rigid polymers while further reducing production costs.

The length of each portion, of the electrodes 122 and 124, immersed in a rigid-polymer-dispersed liquid LN may be 10 mm or more and 1,000 mm or less, 10 mm or more and 500 mm or less, or 10 mm or more and 100 mm or less in order to obtain a molded rigid polymer article containing a higher concentration of rigid polymers while further reducing production costs.

DC voltage applied across the electrodes 122 and 124 may be 0.1 V or more and 100,000 V or less, 1 V or more and 10,000 V or less, 1 V or more and 1,000 V or less, or 10 V or more and 100 V or less in order to obtain a molded rigid polymer article containing a higher concentration of rigid polymers while further reducing production costs. Assumed that a DC voltage of 0.1 V or more and 100,000 V or less is applied across the electrodes 122 and 124. In this case, a DC current value between the electrodes 122 and 124 is, for example, 0.001 A or more and 200 A or less.

Time (application time) for applying DC voltage may be 1 minute or more, or 5 minutes or more in order to obtain a molded rigid polymer article containing a higher concentration of rigid polymers. Time for applying DC voltage may be 15 minute or less, or 10 minutes or less in order to further reduce production costs.

Deposition of rigid polymers forms a molded rigid polymer article on a surface of at least one of the electrodes 122 and 124. The molded rigid polymer article is then, for example separated from the electrodes. Assumed that the rigid polymers are bio-nanofibers. In this case, a molded nanofiber article is used as naturally derived materials that can reduce environmental impact (specifically, industrial materials, food additives, cosmetic additives, and the like).

The molded nanofiber article exhibits antiviral properties against novel coronaviruses. For example, the molded nanofiber article can inactivate 99.8% of novel coronaviruses compared to commercial PET films.

The molded rigid polymer article production method according to the present embodiment has been described above. A molded rigid polymer article production method of the present invention is however not limited to the above-mentioned embodiment.

A molded rigid polymer article production method according to the present embodiment will then be described with reference to FIGS. 1 and 2. FIG. 2 is a flow chart that depicts the molded rigid polymer article production method according to the present embodiment.

As depicted in FIG. 2, a rigid-polymer-dispersed liquid is prepared in Step S102. Typically, the rigid-polymer-dispersed liquid is prepared by adding rigid polymers to a polar medium so that the rigid polymers are dispersed in the polar medium.

In Step S104, a production device 100 is set up. Typically, the rigid-polymer-dispersed liquid LN is poured into a vessel 110 of the production device 100. Electrodes 122 and 124 of the production device 100 are then immersed in the rigid-polymer-dispersed liquid LN.

In Step S106, voltage is applied across the electrodes 122 and 124. When the voltage is applied across the electrodes 122 and 124, the rigid polymers in the rigid-polymer-dispersed liquid LN swim toward one of the electrodes 122 and 124 and are deposited thereon. The rigid polymers then lose their charged state and become gelatinous in one of the electrodes 122 and 124, so that a molded rigid polymer article can be formed thereon.

Typically, drying is applied to the molded rigid polymer article formed on one of the electrodes 122 and 124. The molded rigid polymer article dried exhibits insulating properties. The molded rigid polymer article is subsequently separated from one of the electrodes 122 and 124. Note that a molded rigid polymer article to be used may remain deposited on one of the electrodes 122 and 124. Field strength at an electrode, of the electrodes 122 and 124, on which the molded rigid polymer article is deposited is 500 V/cm or less. As described above, rigid polymers can be used to produce a molded rigid polymer article on one of the electrodes 122 and 124.

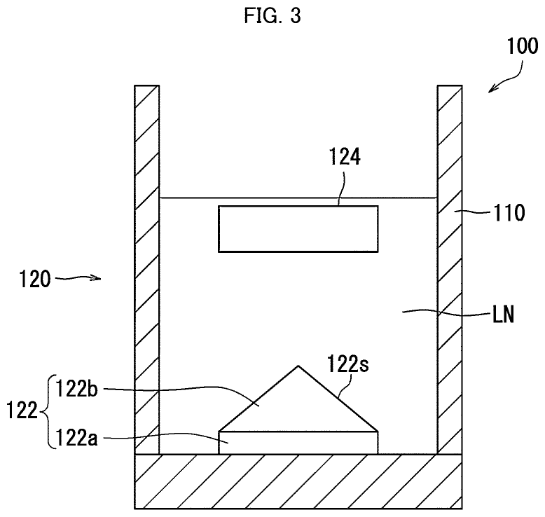

FIG. 3 is a schematic diagram of a production device 100 for producing a molded rigid polymer article according to the present embodiment. The production device 100 in FIG. 3 has the same configuration as the production device 100 in FIG. 1, except that the arrangement and shape of electrodes 120 are different. Duplicate descriptions are omitted for the purpose of avoiding redundancy.

As depicted in FIG. 3, the electrodes 120 are immersed in a dispersion liquid LN. An electrode 122 is placed on a bottom of a vessel 110, while an electrode 124 is placed near the top of the dispersion liquid LN.

Examples of constituent materials of the electrodes 120 include metallic materials and conductive metal oxide materials. Assumed that the metallic materials are employed as the constituent materials of the electrodes 120. In this case, examples of usable metallic materials include copper, silver, and nickel. Alternatively, assumed that the conductive metal oxide materials are employed as the constituent materials of the electrodes 120. In this case, examples of usable conductive metal oxide materials include indium tin oxide (ITO) and antimony doped tin oxide (ATO).

Rigid polymers are deposited on at least one of the electrodes 122 and 124. The rigid polymers are deposited, so that a molded rigid polymer article is formed on at least one of the electrodes 122 and 124. The molded rigid polymer article is formed according to the shape of a surface, of the electrodes 122 and 124, on which the rigid polymers are deposited. This approach enables a molded rigid polymer article to be formed according to the shape of the electrode 122 and/or the electrode 124.

Here, the electrode 122 has a three-dimensional shape. The electrode 122 includes at least one of convex and concave portions. Rigid polymers being deposited on the electrode 122 enables a molded rigid polymer article to be formed into a shape according to the three-dimensional shape of the electrode 122.

In an example, the electrode 122 has a flat portion 122a and a protruding portion 122b. The flat and protruding portions 122a and 122b are conductive. Here, the protruding portion 122b is placed on the flat portion 122a. The protruding portion 122b faces the electrode 124. The protruding portion 122b is, for example conical in shape.

The rigid polymers are deposited on a surface 122s, of the protruding portion 122b, which faces the electrode 124. Here, a convex portion that protrudes toward the electrode 124 is provided at the surface 122s side of the protruding portion 122b. The surface 122s includes areas whose normal directions are different from each other. Note that although the convex portion that protrudes toward the electrode 124 is provided at the surface 122s side of the protruding portion 122b, a depressed concave portion may be provided at the surface 122s side of the protruding portion 122b.

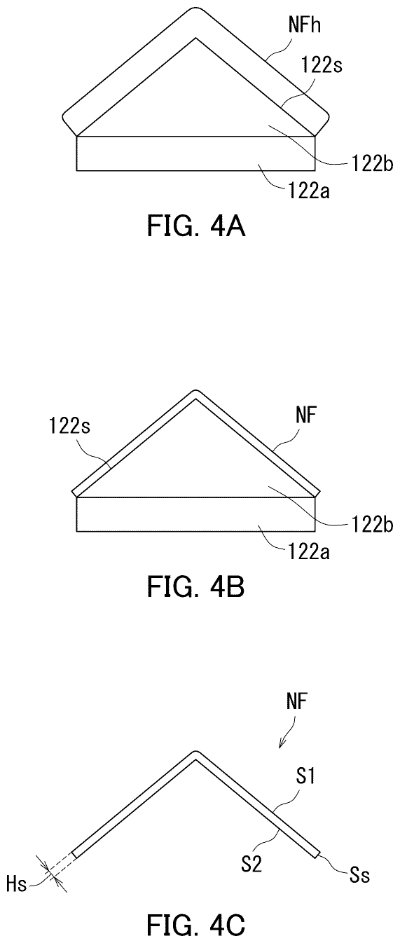

A molded rigid polymer article production method according to the present embodiment will then be described with reference to FIGS. 3 to 4C. FIGS. 4A to 4C illustrates the molded rigid polymer article production method according to the present embodiment.

As depicted in FIG. 4A, voltage is applied across electrodes 122 and 124 in a rigid-polymer-dispersed liquid LN. Rigid polymers are then deposited on the electrode 122 to form a molded rigid polymer article NFh. The molded rigid polymer article NFh contains rigid polymers and a polar medium. The molded rigid polymer article NFh is so-called gelatinous. Assumed that the polar medium of the molded rigid polymer article NFh is water. In this case, the molded rigid polymer article NFh is a hydrogel.

The molded rigid polymer article NFh adheres to the surface of the electrode 122 by, for example, Coulomb or van der Waals force. Typically, the molded rigid polymer article NFh is deposited on the electrode 122 to a certain thickness. The molded rigid polymer article NFh is formed according to the surface shape of the electrode 122. Here, the molded rigid polymer article NFh is formed according to the shape of a protruding portion 122b.

In the case where rigid polymers are cellulose nanofibers, the cellulose nanofibers are deposited on the electrode 122 as an anode. In the case where rigid polymers are chitin nanofibers or chitosan nanofibers, the chitin nanofibers or the chitosan nanofibers are deposited on the electrode 122 as a cathode.

As depicted in FIG. 4B, the polar medium evaporates from the molded rigid polymer article NFh. The molded rigid polymer article NFh then dries to shrink, thereby forming the molded rigid polymer article NFh. Typically, the molded rigid polymer article NFh is taken out together with the electrode 122 from the rigid-polymer-dispersed liquid LN and left in place. This approach enables the polar medium to evaporate from the molded rigid polymer article NFh, thereby forming the molded rigid polymer article NE As a gelatinous molded rigid polymer article NFh dries, the molded rigid polymer article NF shrinks with a constant thickness on the electrode 122. Typically, the molded rigid polymer article NF is 100 nm or more and 200 μm or less in thickness.

As depicted in FIG. 4C, the molded rigid polymer article NF is peeled from the electrode 122. Here, the molded rigid polymer article NF has a shape like a folded thin plate. The surface area of the molded rigid polymer article NF can be varied according to the area of the electrode 122 on which rigid polymers are deposited.

The molded rigid polymer article NF contains nanofibers. Note that the molded rigid polymer article NF may contain components (other components) other than nanofibers. Examples of the other components include resin (binding resin). Examples of usable resin in the case where resin is employed as the other components include epoxy resins, polyurethane resins, acrylic resins, fluoropolymers, phenolic resins, silicone resins, polystyrene resins, polylactic acid resins, polycarbonate resins, polyethylene resins, acrylonitrile butadiene styrene copolymers (ABS resins), polyvinyl chloride resins, polypropylene resins, and polyester resins.

In the present embodiment, the electrode 122 includes a surface 122s on which rigid polymers are deposited. The surface 122s side includes convex or concave portions that are larger than a thickness of the molded rigid polymer article NFh or the molded rigid polymer article NE This approach enables the molded rigid polymer article NF to be formed three-dimensionally on the surface 122s of the electrode 122. It is therefore possible to form the molded rigid polymer article NF into a shape according to a three-dimensional shape of the electrode 122.

A molded rigid polymer article NF in the present embodiment also includes a first principal surface S1, a second principal surface S2 that is a back surface of the first principal surface S1, and a lateral Ss that connects the first and second principal surfaces S1 and S2. Since the molded rigid polymer article NF is formed by depositing rigid polymers on an electrode 122 with a three-dimensional shape, the first and second principal surfaces S1 and S2 typically include a shape corresponding to convex or concave portions of the electrode 122. The shortest distance between the first and second principal surfaces S1 and S2 is constant. In this case, a normal direction of the first principal surface S1 is antiparallel to a normal direction of the second principal surface S2. One of the first and second principal surfaces S1 and S2 includes convex portions larger than a height Hs of the lateral Ss, while the other of the first and second principal surfaces S1 and S2 includes concave portions larger than the height Hs of the lateral Ss.

The molded rigid polymer article NF has the advantages of transparency, light weight, high strength, high heat resistance, high gas barrier, biodegradability, and sustainability. For example, the molded rigid polymer article NF can be used as a substitute for paper. In an example, the molded rigid polymer article NF can be used as wrapping paper or packaging. Alternatively, the molded rigid polymer article NF can be used as a substitute for plastic. For example, the molded rigid polymer article NF can be used as a straw and the like.

Note that although the entire conductive electrode 122 includes a three-dimensional structure in the illustrations depicted in FIGS. 3 and 4A to 4C, the present embodiment is not limited to this. The entire conductive electrode 122 may not include a three-dimensional structure.

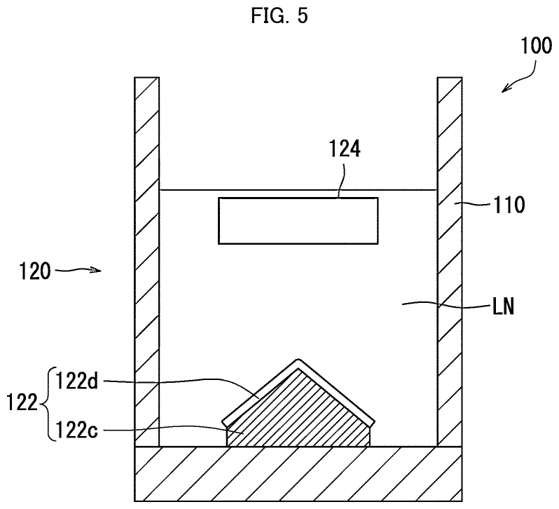

Production of a molded rigid polymer article according to the present embodiment will then be described with reference to FIG. 5. FIG. 5 is a schematic diagram of a production device 100 that produces the molded rigid polymer article according to the present embodiment. The production device 100 in FIG. 5 has the same configuration as the production device 100 in FIG. 3, except that only part of electrodes 120 having a three-dimensional structure is conductive. Duplicate descriptions are omitted for the purpose of avoiding redundancy.

In the production device 100 depicted in FIG. 5, only part of the electrodes 120 having the three-dimensional structure is conductive. Here, an electrode 122 includes a three-dimensional structure and only part of the electrode 122 is conductive.

The electrode 122 include a base 122c and a conductive film 122d. The base 122c is an insulating base, while the conductive film 122d is conductive. The base 122c is conical in shape, for example. The conductive film 122d is placed to cover the sides of the base 122c. The conductive film 122d is formed by sputtering.

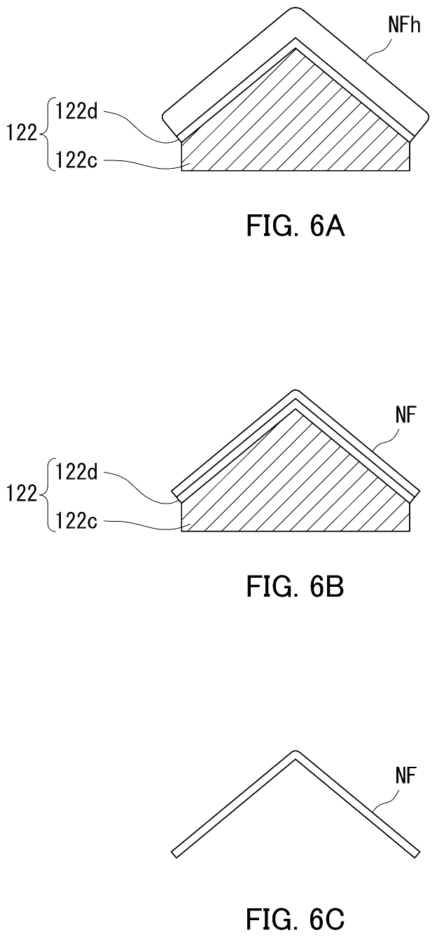

Production of a molded rigid polymer article according to the present embodiment will then be described with reference to FIGS. 5 to 6C. FIGS. 6A to 6C schematically illustrate a molded rigid polymer article production method according to the present embodiment.

As depicted in FIG. 6A, voltage is applied across electrodes 122 and 124 in a rigid-polymer-dispersed liquid LN. Rigid polymers are accordingly deposited on a surface of the electrode 122 to from a molded rigid polymer article NFh. The molded rigid polymer article NFh is formed on a surface of a conductive film 122d. The molded rigid polymer article NFh is formed according to a surface shape of the conductive film 122d. The molded rigid polymer article NFh is gelatinized.

As depicted in FIG. 6B, a polar medium is evaporated from the molded rigid polymer article NFh, so that a molded rigid polymer article NF dried is formed. The molded rigid polymer article NFh dries and then shrinks along the surface shape of the electrode 120, so that a molded rigid polymer article NF in a dry state is formed.

As depicted in FIG. 6C, the molded rigid polymer article NF is separated from the electrode 122. For example, the molded rigid polymer article NF may be peeled from the electrode 122. Alternatively, at least part of the electrode 122 may be dissolved. For example, a base 122c may be dissolved. The base 122c may be dissolved by either heating or chemical treatment. The above approach enables a molded rigid polymer article NF to be produced according to a shape of the electrode 122.

Note that although in FIG. 6A the conductive film 122d remains on the base 122c when the molded rigid polymer article NFh is formed, the present embodiment is not limited to this. The conductive film 122d may ionize as rigid polymers are deposited and then dissolve in a rigid-polymer-dispersed liquid LN. When a molded rigid polymer article NFh is formed, the conductive film 122d may disappear from the top of the base 122c to dissolve in the rigid-polymer-dispersed liquid LN.

The orientation direction of a molded rigid polymer article can be controlled. Specifically, an orientation direction of a molded rigid polymer article depends on the field strength near an electrode on which rigid polymers are deposited. For example, in the case where a molded rigid polymer article is oriented randomly, the molded rigid polymer article is 15% or less in degree of orientation. On the other hand, in the case where a molded rigid polymer article is oriented horizontally or vertically, a molded rigid polymer article can be formed to have a degree of orientation that is 20% or more. A degree of orientation of a molded rigid polymer article varies greatly depending on an applied voltage. For example, in the case where a molded rigid polymer article is oriented horizontally or vertically, the molded rigid polymer article is 20% or more and 90% or less in degree of orientation. The molded rigid polymer article may be, in degree of orientation, 40% or more and 80% or less, or 60% or more and 85% or less.

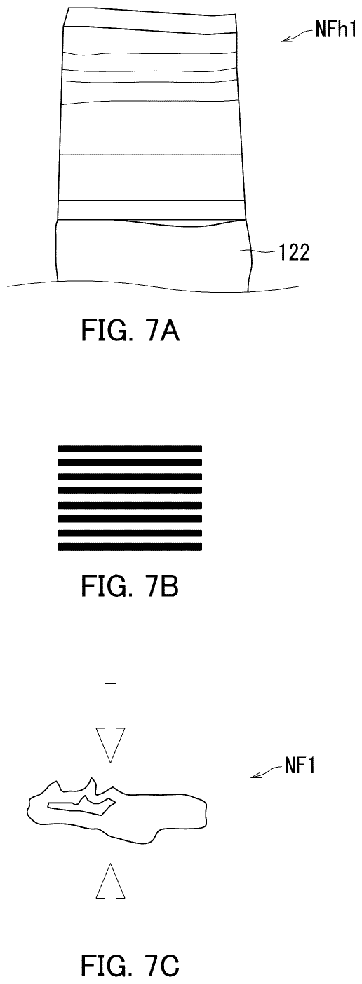

A molded rigid polymer article with different orientation directions and a production method thereof will then be described with reference to FIGS. 7A to 9C.

A molded rigid polymer article that is deposited by applying voltage at a relatively low field strength will first be described with reference to FIGS. 7A to 7C. FIG. 7A is a schematic diagram of a molded rigid polymer article NFh1 that is deposited by applying voltage at a relatively low field strength. FIG. 7B schematically illustrates orientation of rigid polymers in the molded rigid polymer article NFh1 in FIG. 7A. FIG. 7C is a schematic diagram of a molded rigid polymer article NF1 derived from the molded rigid polymer article NFh1 in FIG. 7A that has been dried.

A relatively low voltage is applied to a rigid-polymer-dispersed liquid LN and rigid polymers are then deposited on the top surface of an electrode 122 to form a molded rigid polymer article NFh1. Here, the rigid polymers are deposited on a micro-sized electrode 122.

As depicted in FIGS. 7A and 7B, in the case where voltage is applied at a relatively low field strength, the rigid polymers in the molded rigid polymer article NFh1 are stacked parallel to the surface of the electrode 122.

As depicted in FIG. 7C, the molded rigid polymer article NFh1 shrinks as it dries and then becomes the molded rigid polymer article NF1. Typically, the molded rigid polymer article NFh1 is taken out from the rigid-polymer-dispersed liquid LN and left in place. A polar medium then evaporates from the molded rigid polymer article NFh1. Evaporation of the polar medium dries the molded rigid polymer article NFh1, so that the molded rigid polymer article NFh1 shrinks and becomes the molded rigid polymer article NF1. In this case, the molded rigid polymer article NF1 shrinks parallel to the surface of the electrode 122.

As described above, applying voltage at a relatively low field strength to the electrode 122 in the rigid-polymer-dispersed liquid LN enables the molded rigid polymer article NFh1 to be formed with rigid polymers thereof oriented parallel to the surface of the electrode 122. For example, a molded rigid polymer article NFh1 can be formed with rigid polymers thereof oriented parallel to the surface of the electrode 122 by applying voltage at a field strength of 0.01 V/cm or more and 1 V/cm or less to the electrode 122 in the rigid-polymer-dispersed liquid LN.

A degree of orientation of the molded rigid polymer article NFh1 or the molded rigid polymer article NF1 can be measured using X-rays. For example, the molded rigid polymer articles are 70% in degree of orientation.

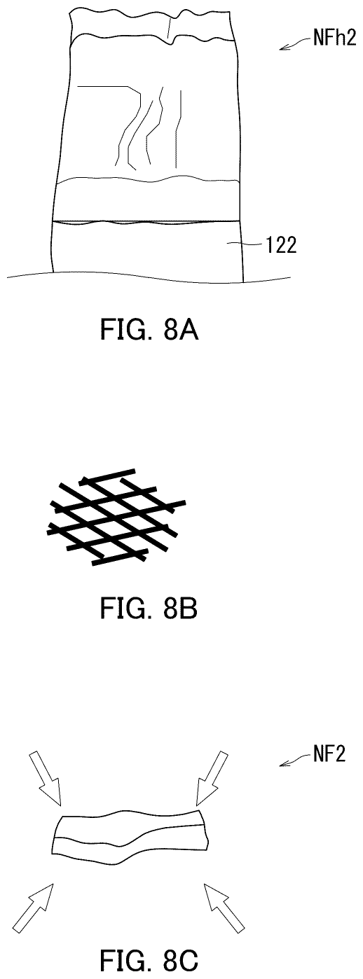

A molded rigid polymer article that is deposited by applying voltage at a moderate field strength will then be described with reference to FIGS. 8A to 8C. FIG. 8A is a schematic diagram of a molded rigid polymer article NFh2 deposited by applying voltage at a moderate field strength. FIG. 8B is a schematic diagram that depicts the orientation of the molded rigid polymer article NFh2 in FIG. 8A. FIG. 8C is a schematic diagram of a molded rigid polymer article NF2 derived from the molded rigid polymer article NFh2 of FIG. 8A that has been dried.

As depicted in FIGS. 8A and 8B, voltage at a moderate field strength is applied to a rigid-polymer-dispersed liquid LN and the molded rigid polymer article NFh2 is then deposited on the top surface of an electrode 122. Here, rigid polymers are deposited on a micro-sized electrode 122. Rigid polymers in the molded rigid polymer article NFh2 are randomly stacked on the surface of the electrode 122.

As depicted in FIG. 8C, the molded rigid polymer article NFh2 dries and then becomes a molded rigid polymer article NF2. Typically, the molded rigid polymer article NFh2 is taken out from the rigid-polymer-dispersed liquid LN and left in place. A polar medium then evaporates from the molded rigid polymer article NFh2. Evaporation of the polar medium dries the molded rigid polymer article NFh2, so that the molded rigid polymer article NFh2 shrinks and becomes the molded rigid polymer article NF2. In this case, the molded rigid polymer article NF2 shrinks in multiple directions relative to the surface of the electrode 122.

As described above, applying voltage at a moderate field strength to the electrode 122 in the rigid-polymer-dispersed liquid LN enables the molded rigid polymer article NFh2 to be formed with rigid polymers thereof randomly oriented relative to the surface of the electrode 122. For example, a molded rigid polymer article NFh2 can be formed with rigid polymers thereof randomly oriented relative to the surface of the electrode 122 by applying voltage at a field strength of 2.1 V/cm or more and 5 V/cm or less to the electrode 122 in the rigid-polymer-dispersed liquid LN.

A degree of orientation of the molded rigid polymer article NFh2 or the molded rigid polymer article NF2 can be measured using X-rays. In the case where rigid polymers are randomly oriented relative to the surface of the electrode 122, the molded rigid polymer articles are 5% in degree of orientation.

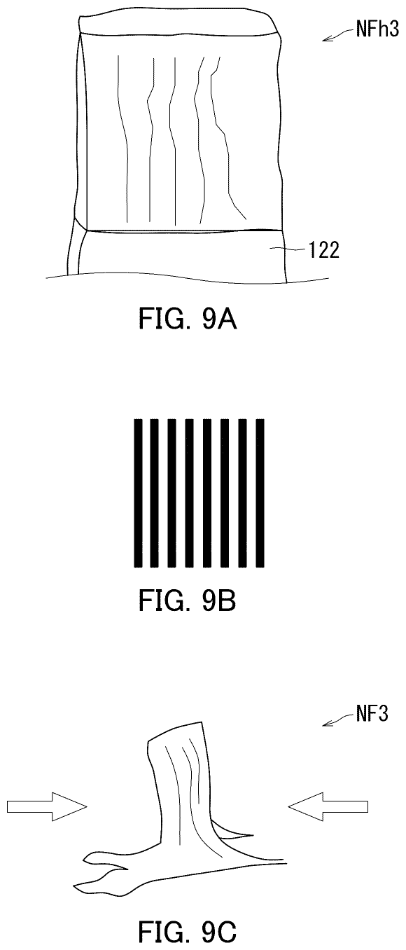

A molded rigid polymer article that is produced by applying voltage at a relatively high field strength will then be described with reference to FIGS. 9A to 9C. FIG. 9A is a schematic diagram of a molded rigid polymer article NFh3 produced by applying voltage at a relatively high field strength. FIG. 9B is a schematic diagram that depicts the orientation of the molded rigid polymer article NFh3 in FIG. 9A. FIG. 9C is a schematic diagram of a molded rigid polymer article NF3 derived from the molded rigid polymer article NFh3 of FIG. 9A that has been dried.

As depicted in FIGS. 9A and 9B, voltage at a relatively high field strength is applied to a rigid-polymer-dispersed liquid LN and the molded rigid polymer article NFh3 is then deposited on the top surface of an electrode 122. Here, rigid polymers are deposited on a micro-sized electrode 122. Rigid polymers in the molded rigid polymer article NFh3 are stacked perpendicular to the surface of the electrode 122.

As depicted in FIG. 9C, the molded rigid polymer article NFh3 dries and then becomes a molded rigid polymer article NF3. Typically, the molded rigid polymer article NFh3 is taken out from the rigid-polymer-dispersed liquid LN and left in place. A polar medium then evaporates from the molded rigid polymer article NFh3. Evaporation of the polar medium dries the molded rigid polymer article NFh3, so that the molded rigid polymer article NFh3 shrinks and becomes the molded rigid polymer article NF3. In this case, the molded rigid polymer article NF3 shrinks perpendicular to the surface of the electrode 122.

As described above, applying voltage at a relatively high field strength to the electrode 122 in the rigid-polymer-dispersed liquid LN enables the molded rigid polymer article NFh3 to be formed with rigid polymers thereof oriented perpendicular to the surface of the electrode 122. For example, a molded rigid polymer article NFh3 can be formed with rigid polymers thereof oriented perpendicular to the surface of the electrode 122 by applying voltage at a field strength of 5.1 V/cm or more and 50 V/cm or less to the electrode 122 in the rigid-polymer-dispersed liquid LN.

A degree of orientation of the molded rigid polymer article NFh3 or the molded rigid polymer article NF3 can be measured using X-rays. In the case where rigid polymers are oriented perpendicular to the surface of the electrode 122, the molded rigid polymer articles are 70% in degree of orientation.

As described above, the orientation direction of rigid polymers in a molded rigid polymer article NFh can be controlled by controlling field strength applied to the electrode 122 in the rigid-polymer-dispersed liquid LN.

A molded rigid polymer article NF is formed according to the surface of an electrode 122 as described with reference to FIGS. 3 to 6C. In this case, field strength at the electrode 122 is preferably 0.01 V/cm or more and 2 V/cm or less so that a molded rigid polymer article NFh1 is formed with rigid polymers thereof oriented horizontally relative to the surface of the electrode 122. This approach prevents a molded rigid polymer article NF from cracking when a molded rigid polymer article NFh shrinks even if the molded rigid polymer article NF is relatively thin.

Note that a molded rigid polymer article formed in horizontal orientation was found to have low-friction properties, especially in a pre-dried hydrogel state. For example, the molded rigid polymer article formed in horizontal orientation can reduce the coefficient of friction to ⅓ to 1/27 of that of a molded rigid polymer article formed in random orientation. This makes molded rigid polymer articles formed in horizontal orientation suitable for use in artificial cartilage and/or lubricating coatings.

As described above, molded rigid polymer articles can be formed into a three-dimensional shape according to surface shapes of electrodes. Note that molded rigid polymer articles may be formed in a projecting shape. For example, the molded rigid polymer articles can be applied to microneedles.

### Second Embodiment

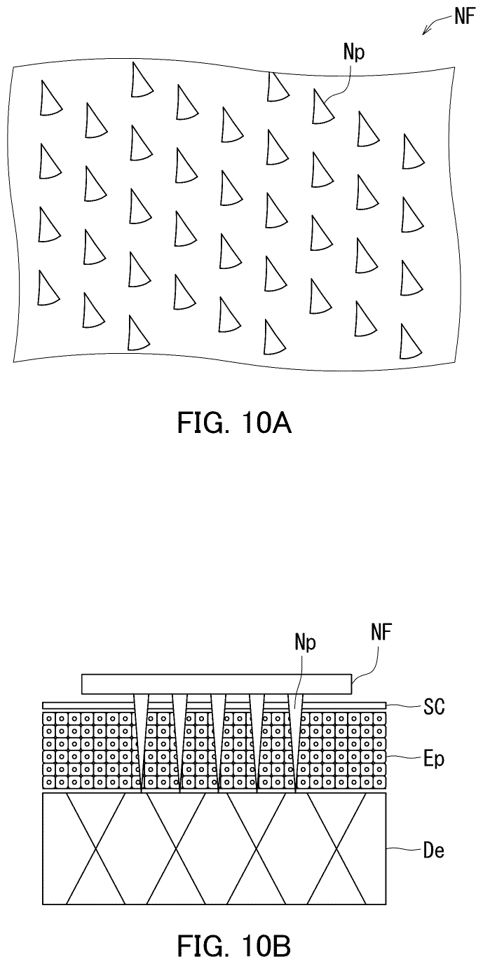

A molded rigid polymer article and a molded rigid polymer article production method according to the present embodiment will now be described with reference to FIGS. 10A to 15. FIG. 10A is a schematic diagram of the molded rigid polymer article according to the present embodiment. FIG. 10B schematically illustrates that the molded rigid polymer article in FIG. 10A is used for microneedles.

As depicted in FIG. 10A, a molded rigid polymer article NF includes protrusions Np. Here, the protrusions Np are arranged in a matrix. For examples, the protrusions Np are 100 μm or more and 500 μm or less in height. The protrusions Np are 5 μm or more and 1 mm or less in width. In this case, the molded rigid polymer article NF is suitable for use in intradermal injection of drug solutions into the skin.

As depicted in FIG. 10B, the molded rigid polymer article NF can be used as microneedles. The molded rigid polymer article NF is pressed against the skin with a chemical solution applied to the protrusions Np of the molded rigid polymer article NE The tips of the protrusions Np of the molded rigid polymer article NF then penetrates the stratum corneum Sc and epidermis Ep and then reaches the interface between the epidermis Ep and the dermis De. This allows the drug solutions to be injected around the interface between the epidermis Ep and the dermis De without allowing the molded rigid polymer article NF to reach pain-sensing nerves.

Here, the drug solutions are injected around the interface between the epidermis Ep and the dermis De as described above. Heights of the protrusions Np may however be adjusted according to respective types of drug solutions for subcutaneous, intravenous, and intramuscular injections.

As described above, the molded rigid polymer article NF can be suitably applied to microneedles.

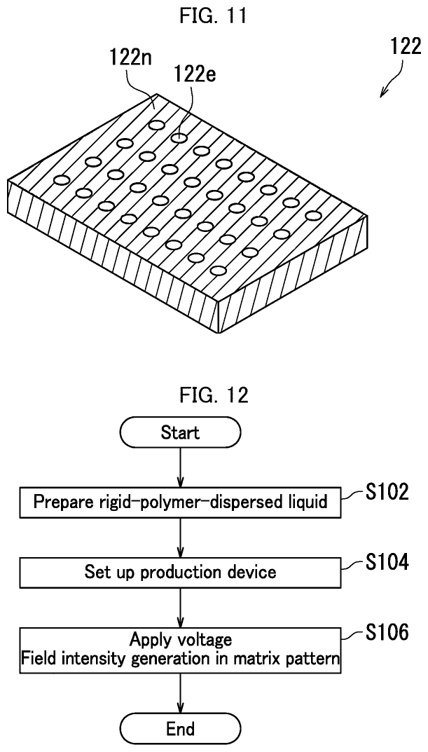

Production of a molded rigid polymer article NF according to the present embodiment will then be described with reference FIG. 11. FIG. 11 is a schematic perspective view of an electrode 122 used for producing the molded rigid polymer article NF according to the present embodiment.

As depicted in FIG. 11, the electrode 122 includes an insulating plate 122n and conductive portions 122e. The conductive portions 122e are arranged in a matrix in the insulating plate 122n.

The insulating plate 122n has electrical insulating properties. Examples of constituent materials of the insulating plate 122n include polyimide resin, paper-phenolic resin composite material in which paper is impregnated with phenolic resin, and glass-epoxy resin composite material in which woven glass fabric (cloth) is impregnated with epoxy resin. The insulating plate 122n is, for example, 10 μm or more and 5 mm or less in thickness.

The insulating plate 122n is provided with openings. The openings are arranged in a matrix in the insulating plate 122n. The conductive portions 122e are placed in the openings of the insulating plate 122n. The conductive portions 122e are therefore arranged in a matrix in the insulating plate 122n.

The conductive portions 122e are, for example, 5 μm or more and 1 mm or less in width. The conductive portions 122e are arranged at intervals of 5 μm or more and 1 mm or less. The molded rigid polymer article is formed corresponding to the conductive portions 122e.

A molded rigid polymer article NF is produced corresponding to the conductive portions 122e of the electrode 122. Typically, protrusions Np of the molded rigid polymer article NF are formed on respective positions corresponding to the conductive portions 122e of the electrode 122 so as to protrude from respective top surfaces of the conductive portions 122e. A molded rigid polymer article NF as depicted in FIG. 10A can therefore be formed by the electrode 122 depicted in FIG. 11

A production method of a molded rigid polymer article NF, according to the present embodiment will then be described with reference to FIGS. 10A to 12. FIG. 12 is a flow chart that depicts the production method of the molded rigid polymer article NF, according to the present embodiment.

In Step S102, a rigid-polymer-dispersed liquid LN is prepared. Typically, a rigid-polymer-dispersed liquid LN in which rigid polymers are dispersed in a polar medium can be prepared by adding the rigid polymers to the polar medium.

In Step S104, a production device 100 is set up. Typically, the rigid-polymer-dispersed liquid LN is poured into a vessel 110. Electrodes 122 and 124 of the production device 100 are also immersed in the rigid-polymer-dispersed liquid LN. For example, in the production device 100, an electrode 122 as depicted in FIG. 11 is placed in the rigid-polymer-dispersed liquid LN.

In Step S106, voltage is applied across the electrodes 122 and 124. The voltage applied generates field strength in a matrix pattern at the electrode 122. This enables a molded rigid polymer article NF to be formed on the electrode 122 with protrusions Np arranged in a matrix pattern.

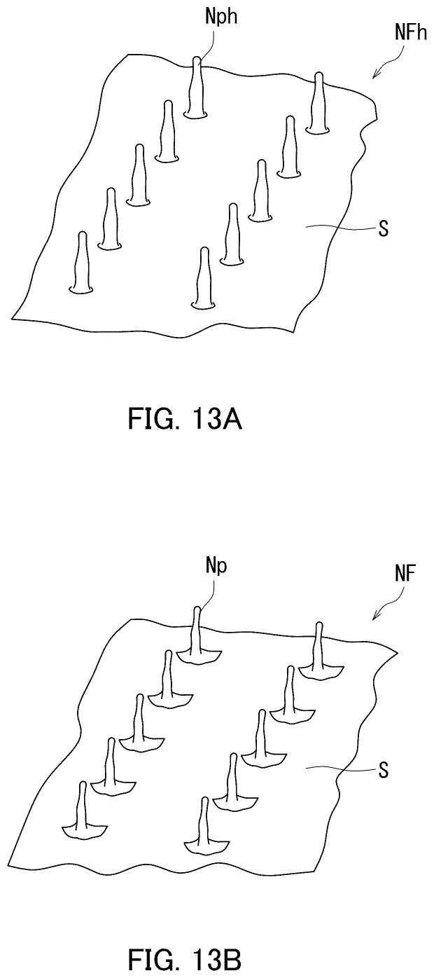

A molded rigid polymer article NF according to the present embodiment will then be described with reference to FIGS. 13A and 13B. FIG. 13A is a schematic diagram of a molded rigid polymer article NFh before drying according to the present embodiment. FIG. 13B is a schematic diagram of a molded rigid polymer article NF after drying according to the present embodiment.

The molded rigid polymer article NFh is formed on the surface of a substrate S as depicted in FIG. 13A. The molded rigid polymer article NFh includes protrusions Nph. The protrusions Nph are arranged in a matrix on the top surface of the substrate S.

The substrate S has electrical insulating properties. The substrate S preferably allows a rigid-polymer-dispersed liquid LN to permeate or pass through in a thickness direction of the substrate S while the substrate S is immersed in the rigid-polymer-dispersed liquid LN. The substrate S is porous. Holes of the substrate S may be formed by the constituent materials of the substrate S, or may be through-holes that physically penetrate the substrate S. The substrate S may be, for example paper. Examples of the substrate S may further include polyimide resin, paper-phenolic resin composite material in which paper is impregnated with phenolic resin, and glass-epoxy resin composite material in which woven glass fabric (cloth) is impregnated with epoxy resin. The substrate S is, for example, 10 μm or more and 5 mm or less in thickness.

As depicted in FIG. 13B, a molded rigid polymer article NF dried is formed by evaporation of a polar medium from the molded rigid polymer article NFh. Protrusions Np in the molded rigid polymer article NF are arranged in a matrix on the top surface of the substrate S like the protrusions Nph of the molded rigid polymer article NFh. However, the protrusions Np in the molded rigid polymer article NF are smaller than the protrusions Nph of the molded rigid polymer article NFh. Typically, the protrusions Np are 100 μm or more and 500 μm or less in height. The protrusions Np are 5 μm or more and 1 mm or less in width.

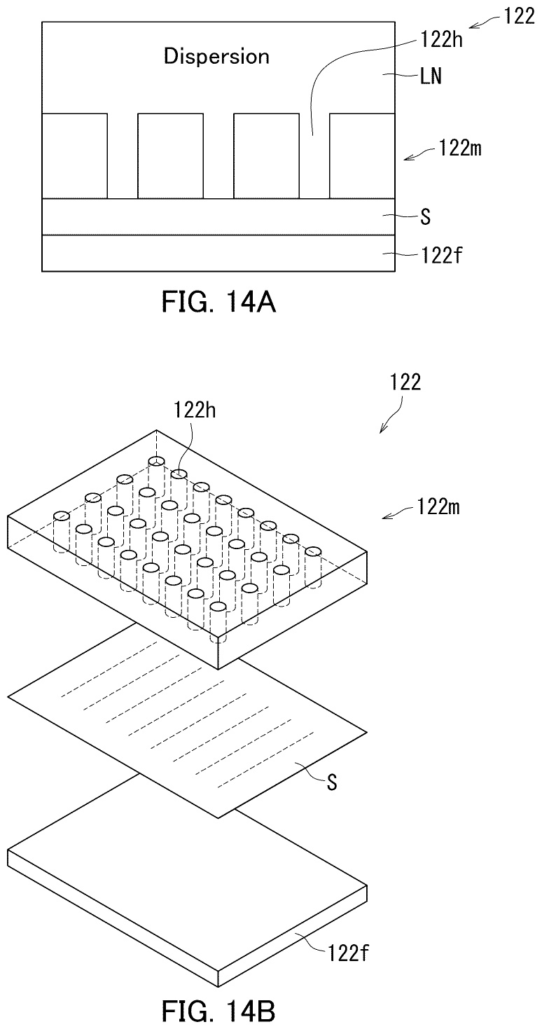

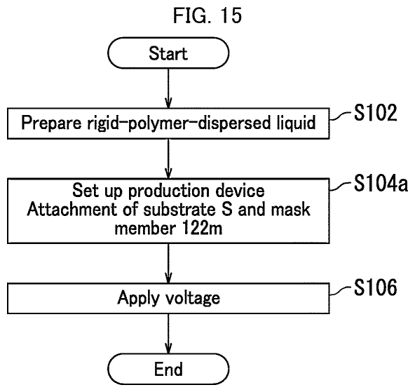

Production of a molded rigid polymer article according to the present embodiment will then be described with reference to FIGS. 14A and 14B. FIG. 14A is a schematic diagram of the vicinity of an electrode 122 in a production device 100. FIG. 14B is a schematic exploded view of the electrode 122 in FIG. 14A.

As depicted in FIGS. 14A and 14B, the electrode 122 includes a conductive plate 122f, a substrate S, and a mask member 122m. The substrate S is placed on the conductive plate 122f. The mask member 122m is placed on the substrate S. The substrate S intervenes between the conductive plate 122f and the mask member 122m.

A rigid-polymer-dispersed liquid penetrates at least part of the substrate S. The substrate S may be porous. Alternatively, the substrate S may be provided with through-holes.

The mask member 122m is placed on the substrate S. The mask member 122m is formed from an insulating material. The mask member 122m is provided with predetermined through-holes 122h. Typically, the mask member 122m is provided with predetermined through-holes 122h in a matrix.

Voltage is applied to the conductive plate 122f and protrusions of a molded rigid polymer article are then formed at regions, of the conductive plate 122f, corresponding to the through-holes 122h of the mask member 122m. The through-holes 122h are arranged in a matrix, so that the molded rigid polymer article includes the protrusions corresponding to the through-holes 122h.

FIG. 15 is a flow chart that depicts a molded rigid polymer article production method according to the present embodiment.

As depicted in FIG. 15, in Step S102, a rigid-polymer-dispersed liquid is prepared. Typically, rigid polymers are added to a polar medium. As a result, a rigid-polymer-dispersed liquid is prepared with the rigid polymers dispersed in the polar medium.

In Step S104a, a production device 100 is set up. Typically, a rigid-polymer-dispersed liquid LN is poured into a vessel 110 of a production device 100. Electrodes 122 and 124 of the production device 100 are then immersed in the rigid-polymer-dispersed liquid LN. Here, a substrate S and a mask member 122m are attached to the electrode 122 of the production device 100.

In Step S106, voltage is applied across the electrodes 122 and 124. The voltage is applied, so that protrusions of a molded rigid polymer article NFh are formed in a matrix pattern at the electrode 122. As described above, a molded rigid polymer article NFh can be formed on the electrode 122 with protrusions Np arranged in a matrix pattern.

The above approach in the present embodiment enables a molded rigid polymer article NF to be formed from a rigid-polymer-dispersed liquid LN.

Note that the molded rigid polymer article NF may have thermal insulation. For example, rigid polymers may be dried in aerogel form to have thermal insulation.

### Third Embodiment

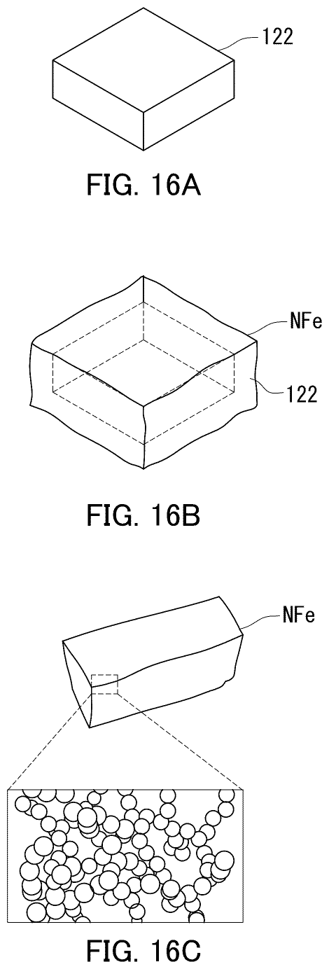

A molded rigid polymer article and a molded rigid polymer article production method according to the present embodiment will now be described with reference to FIGS. 16A to 18C. FIG. 16A is a schematic perspective view of an electrode 122 in a production device 100 for producing a molded rigid polymer article according to the present embodiment. FIG. 16B is a schematic diagram of an aerogel-like molded rigid polymer article NFe formed on the electrode 122 of FIG. 16A. FIG. 16C is a schematic diagram that depicts a structure of the molded rigid polymer article NFe of FIG. 16B.

As depicted here in FIG. 16A, the electrode 122 has a shape like a rectangular cuboid. The electrode 122 is used for the production device 100 for producing a molded rigid polymer article. Typically, a rigid-polymer-dispersed liquid LN is poured into a vessel 110. Electrodes 122 and 124 of the production device 100 are also immersed in the rigid-polymer-dispersed liquid LN.

Voltage is applied across the electrodes 122 and 124. Rigid polymers are consequently deposited on the electrode 122 to form a gelatinous molded rigid polymer article. A subsequent process step includes freeze drying or supercritical drying of the gelatinous molded rigid polymer article by which polar medium of the gelatinous molded rigid polymer article is replaced by air. This approach makes it possible to form an aerogel-like molded rigid polymer article.

The freeze-drying allows to solidify a polar medium in a molded rigid polymer article NFh at a temperature below the freezing point thereof to dry and remove the polar medium by sublimation while in that state. According to a temperature inside a dryer, the polar medium in the molded rigid polymer article NFh is frozen and the molded rigid polymer article is subsequently heated under low pressure to evaporate the polar medium by sublimation. This allows the polar medium in the molded rigid polymer article NFh to be removed while maintaining a rigid polymer framework in the molded rigid polymer article NFh. It is therefore possible to form an aerogel-like molded rigid polymer article NFe.

The supercritical drying allows the polar medium in the molded rigid polymer article NFh to be dried and removed using a supercritical fluid. Typically, carbon dioxide is used as the supercritical fluid. Carbon dioxide is prepared at high temperature and high pressure and the polar medium in the molded rigid polymer article NFh is replaced with the carbon dioxide. The temperature and the pressure are subsequently returned to ambient temperature and pressure, so that the carbon dioxide is further replaced by air. This allows the polar medium in the molded rigid polymer article NFh to be removed while maintaining a rigid polymer framework in the molded rigid polymer article NFh. It is therefore possible to form an aerogel-like molded rigid polymer article NFe.

As depicted in FIG. 16B, the molded rigid polymer article NFe covers the electrode 122. The molded rigid polymer article NFe is formed according to the surface shape of the electrode 122.

As depicted as FIG. 16C, in the aerogel-like molded rigid polymer article NFe, the rigid polymer skeleton is filled with air. The molded rigid polymer article NFe therefore exhibits high thermal insulation performance.

The molded rigid polymer article is suitable for use in a cover of a pipe that allows hot liquids to flow through. The molded rigid polymer article is also used to cover an IC chip to protect the IC chip from ambient heat. Alternatively, the molded rigid polymer article is suitable for use in space-related equipment by utilizing the thermal insulation performance thereof.

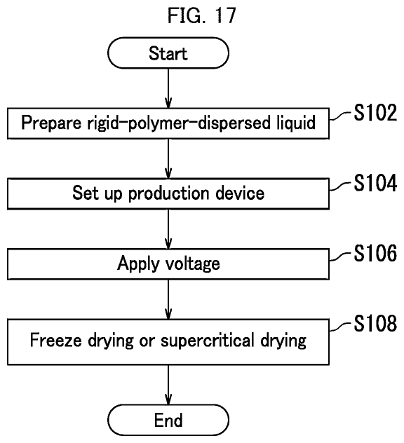

A molded rigid polymer article production method according to the present embodiment will then be described with reference to FIGS. 16A to 17. FIG. 17 is a flow chat that depicts the molded rigid polymer article production method according to the present embodiment.

As depicted in FIG. 17, in Step S102, a rigid-polymer-dispersed liquid is prepared. Typically, a rigid-polymer-dispersed liquid in which rigid polymers are dispersed in a polar medium is prepared by adding the rigid polymers to the polar medium.

In Step S104, a production device 100 is set up. Typically, a rigid-polymer-dispersed liquid LN is poured into a vessel 110 of the production device 100. Electrodes 122 and 124 of the production device 100 are subsequently immersed in the rigid-polymer-dispersed liquid LN.

In Step S106, voltage is applied across the electrodes 122 and 124. This enables a molded rigid polymer article that is gelatinous to be formed on one of the electrodes 122 and 124. Assumed that a polar medium of the rigid-polymer-dispersed liquid LN is water. In this case, the molded rigid polymer article is a hydrogel.

A process step in Step S108 includes freeze drying or supercritical drying of the molded rigid polymer article. The freeze drying or the supercritical drying is applied to the molded rigid polymer article, so that an aerogel-like molded rigid polymer article is formed.

In the present embodiment as described above, an aerogel-like molded rigid polymer article can be formed from a rigid-polymer-dispersed liquid.

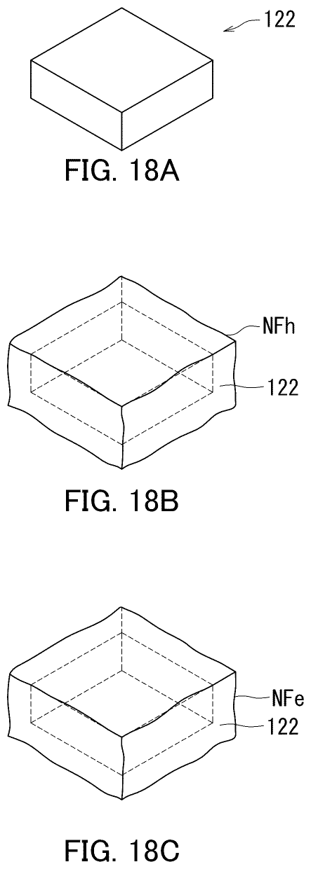

A molded rigid polymer article production method according to the present embodiment will then be described with reference to FIGS. 18A to 18C. FIG. 18A is a schematic perspective view of an electrode 122 for use in production of a molded rigid polymer article according to the present embodiment. FIG. 18B is a schematic diagram of a molded rigid polymer article NFh in which rigid polymers are deposited on the electrode of FIG. 18A. FIG. 18C is a schematic diagram of a molded rigid polymer article NFe derived from the molded rigid polymer article NFh of FIG. 18B to which freeze drying or supercritical drying has been applied.

As depicted in FIG. 18A, the electrode 122 is prepared. Here, the electrode 122 has a shape like a rectangular cuboid. In a rigid-polymer-dispersed liquid LN, voltage is applied across electrodes 122 and 124. As a result, a molded rigid polymer article NFh is formed on the electrode 122.

As depicted in FIG. 18B, the molded rigid polymer article NFh is formed to cover the electrode 122. The molded rigid polymer article NFh is therefore formed according to the surface shape of the electrode 122. Freeze drying or supercritical drying is subsequently applied to the molded rigid polymer article NFh, thereby forming a molded rigid polymer article NFe.

As depicted in FIG. 18C, the molded rigid polymer article NFe is formed to cover the electrode 122. The molded rigid polymer article NFe is an aerogel. The molded rigid polymer article NFe is formed by evaporation of a polar medium from the molded rigid polymer article NFh while a skeleton of the molded rigid polymer article NFh is generally maintained. The molded rigid polymer article NFe is therefore formed according to the surface shape of the electrode 122.

As described above, the molded rigid polymer article NFe with high thermal insulation can be formed according to the surface shape of the electrode 122.

### EXAMPLE

Examples of the present invention will be described below. However, the present invention is in no way limited to the scope of the following examples.

### First Example

### [Preparation of Cellulose-Nanofiber-Dispersed Liquid]

A cellulose-nanofiber-dispersed liquid was first prepared by adding 2 g of cellulose nanofibers to 1,000 g of water. The cellulose nanofibers were 3 nm in average fiber diameter and 300 nm in average length.

### [Formation of Molded Cellulose Nanofiber Article]

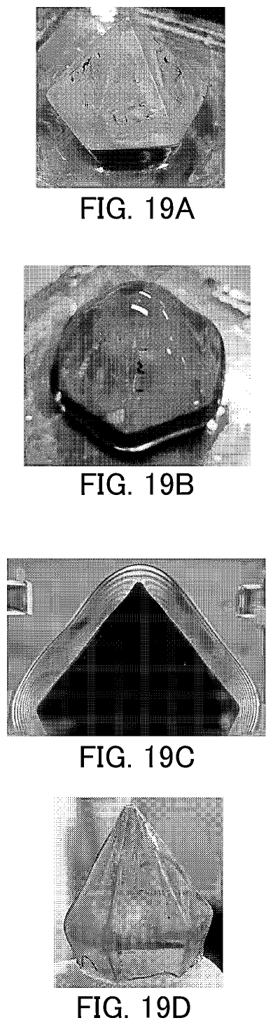

As depicted in FIG. 19A, an electrode model was prepared. The electrode model was obtained by covering the surface of a pentagonal pyramid made of wax with a conductive thin film. A production device was set up with the electrode model as an anode. The distance between the anode and a cathode was 4 cm.

The anode and the cathode were then immersed in the cellulose-nanofiber-dispersed liquid. A molded cellulose nanofiber article was then formed on the surface of the anode by applying a voltage of 1 V across the anode and the cathode. During application of the voltage, field strength near the anode was 0.25 V/cm.

As depicted in FIG. 19B, cellulose nanofibers were deposited on the anode of the electrode model. As a result, a molded cellulose nanofiber article was formed.

As depicted in FIG. 19C, it was confirmed from a cross section obtained by cutting the molded cellulose nanofiber article that cellulose nanofibers of the molded cellulose nanofiber article were oriented parallel to the surface of the anode.

As depicted in FIG. 19D, the molded cellulose nanofiber article was separated from the anode by heating the anode to melt the wax. As a result, a molded cellulose nanofiber article with a hollow pentagonal pyramid shape was formed.

A molded cellulose nanofiber article was next formed on the surface of an anode by applying a voltage of 1 V across the anode and a cathode with the anode and the cathode immersed in a cellulose-nanofiber-dispersed liquid. At that time, field strength at the anode was 0.25 V/cm.

### [Orientation Direction of Samples A to C]

Respective orientations of Samples A to C were measured in response to the field strength at an anode by varying voltage across the anode and a cathode, using the cellulose-nanofiber-dispersed liquid described above. Here, an electrode of size 5 mm square was used as the anode.

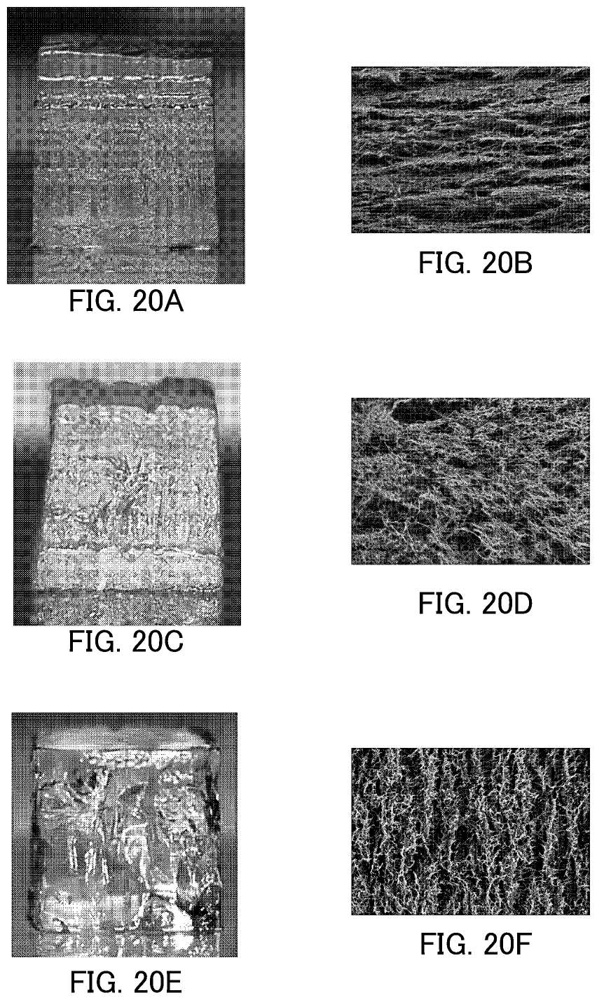

Sample A was produced by applying a voltage of 1 V across the anode and the cathode. FIG. 20A depicts Sample A. Field strength at the anode was 0.25 V/cm during application of the voltage of 1 V across the anode and the cathode. Sample A was photographed under a microscope.

FIG. 20B is a microscopic image of Sample A. In Sample A, cellulose nanofibers were oriented parallel to the surface of the electrode.

Sample B was produced by applying a voltage of 5 V across the anode and the cathode. FIG. 20C depicts Sample B. Field strength at the anode was 1.25 V/cm during application of the voltage of 5 V across the anode and the cathode. Sample B was photographed under the microscope.

FIG. 20D is a microscopic image of Sample B photographed. In Sample B, cellulose nanofibers were oriented in multiple directions relative to the surface of the electrode.

Sample C was produced by applying a voltage of 30 V across the anode and the cathode. FIG. 20E depicts Sample C. Field strength at the anode was 7.5 V/cm during application of the voltage of 30 V across the anode and the cathode. Sample C was photographed under the microscope.

FIG. 20F is a microscopic image of Sample C photographed. In Sample C, cellulose nanofibers were oriented perpendicular to the surface of the electrode.

### Second Example

An anode was formed by placing paper and a mask member on a conductive plate of size 40 mm square. The mask member was made of acrylic and was 40 mm square in size. The mask member was provided with a matrix of through-holes with a diameter of 500 μm. Adjacent through-holes were located 1.5 mm apart.

A molded cellulose nanofiber article was formed on the surface of paper by applying a voltage of 30 V across the anode and a cathode with the anode and the cathode immersed in a cellulose-nanofiber-dispersed liquid. Field strength at the anode was 7.5 V/cm.

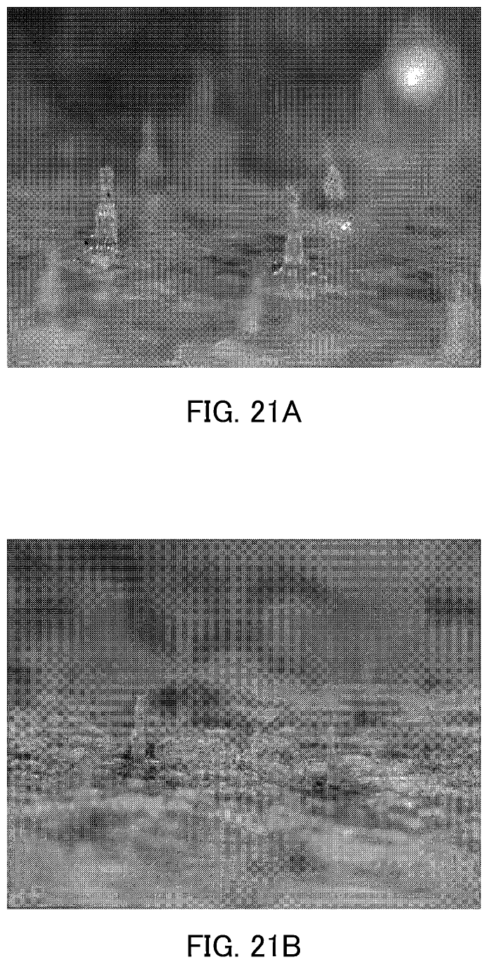

As depicted in FIG. 21A, a molded cellulose nanofiber article with multiple protrusions on paper was formed.

The molded cellulose nanofiber article was subsequently dried by being kept at room temperature for 1 hour. As depicted in FIG. 21B, the protrusions shrank compared to that before drying.

### Third Example

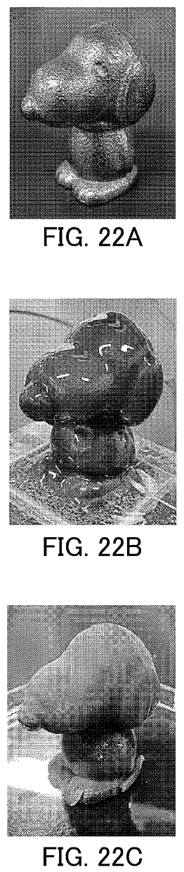

As depicted in FIG. 22A, a member made of iron was used as an anode. The member is in the shape of a dog with a large head with an uneven surface. The anode and a flat cathode were immersed in a cellulose-nanofiber-dispersed liquid of a production device. Voltage was then applied across the anode and the cathode in the cellulose-nanofiber-dispersed liquid.

As depicted in FIG. 22B, hydrogel cellulose nanofibers were deposited on the surface of the anode by the voltage applied. The hydrogel cellulose nanofibers were deposited on the surface of the anode at a nearly constant thickness. A molded hydrogel cellulose nanofiber article was consequently formed with a surface shape thereof being generally the same as that of the anode.

Supercritical drying is then applied to the hydrogel cellulose nanofibers, so that aerogel nanofibers were formed from hydrogel cellulose nanofibers. The supercritical drying was performed using supercritical CO₂ at a temperature of 40° C. and pressure of 10 MPa.

The supercritical drying evaporated water from the molded hydrogel cellulose nanofiber article to form a molded aerogel nanofiber article, as depicted in FIG. 22C. The surface shape of the molded aerogel nanofiber article was also generally the same as that of the anode.

### [Antiviral Test]

An aqueous solution containing SARS CoV 2 (JPN/TY/WK 521) as a virus strain was dropped onto a film of the molded hydrogel cellulose nanofiber article, and the solution was collected 2 hours later to evaluate an infectious titer. For comparison, infectious virus titers were evaluated in comparison to commercially available PET films.

TABLE 1

| | LogTCID50/mL | LRV | Decrease % |
|---|---|---|---|
| Test sample (n1) | 3.44 | 2.266 | 99.458 |
| Control sample (PET film) | 5.70 | — | — |
| Virus stock solution | 6.43 | — | — |
| Test sample (n2) | 3.20 | 3.58 | 99.973 |
| Control sample (PET film) | 6.78 | — | — |
| Virus stock solution | 6.91 | — | — |
| Test sample (n3) | 3.20 | 3.82 | 99.984 |
| Control sample (PET film) | 7.02 | — | — |
| Virus stock solution | 6.79 | — | — |

In the above table, TCID50 indicates 50% tissue culture infectious dose. LRV indicates a logarithmic reduction value.

As will be appreciated from the above table, 99.8% of viruses were inactivated in the molded hydrogel cellulose nanofiber articles compared to commercial PET films.

### [Friction Test]

The coefficient of friction of a molded nanofiber article formed in horizontal orientation was evaluated. A constant load test was performed using a measuring instrument (Tribogear TYPE 14FW manufactured by Shinto Scientific Co., Ltd). In the constant load test, a load was applied by moving a 30 mm flat indenter with a load of 100 g from a distance of 100 mm at a speed of 300 mm/m.

Test samples prepared were cellulose nanofiber hydrogel formed in random orientations and cellulose nanofiber hydrogel formed in horizontal orientation. In the random orientations of the cellulose nanofiber hydrogel, a voltage of 5 V was applied across the anode and the cathode, and field strength at the anode was 1.25 V/cm. In the horizontal orientation of the cellulose nanofiber hydrogel, a voltage of 1 V was applied across the anode and the cathode, and field strength at the anode was 0.25 V/cm. Test samples further prepared were respective alginic acid hydrogels similarly formed in random and horizontal orientations.

TABLE 2

| | Coefficient of | Coefficient of |
|---|---|---|
| | static friction μs | kinetic friction μk |
| | (average, n = 3) | (average, n = 3) |
| Cellulose nanofiber hydrogel | 0.428 | 0.244 |
| (random orientations) | | |
| Cellulose nanofiber hydrogel | 0.174 | 0.074 |
| (horizontal orientation) | | |
| Alginic acid hydrogel | 0.521 | 0.485 |
| (random orientations) | | |
| Alginic acid hydrogel | 0.086 | 0.018 |
| (horizontal orientation) | | |

As will be appreciated from the above table, the value of each horizontal orientation was reduced compared to the value of corresponding random orientations for any of the coefficient of static friction and the coefficient of kinetic friction for each of the cellulose nanofiber hydrogels and the alginic acid hydrogels. Especially, the coefficient of kinetic friction in the case of the cellulose nanofiber hydrogel was reduced to approximately ⅓, while the coefficient of kinetic friction in the case of the alginic acid hydrogel was reduced to approximately 1/27.

Embodiments and examples of the present invention are described above with reference to the accompanying drawings. However, the present invention is not limited to the above embodiments and examples and may be implemented in various manners within a scope not departing from the gist thereof. Furthermore, various inventions may be formed by appropriately combining constituent elements disclosed in the above embodiments. For example, some constituent elements may be removed from all of the constituent elements illustrated in the embodiments. Additionally, constituent elements may be appropriately combined across different embodiments. The drawings mainly illustrate the constituent elements schematically to facilitate understanding thereof. Aspects such as thickness, length, number, and interval of the constituent elements illustrated in the drawings may differ in practice for convenience of drawing preparation. Furthermore, aspects such as material, shape, and dimension of the constituent elements illustrated in the above embodiments are examples and not particular limitations. The constituent elements may be variously altered within a scope not substantively departing from the effects of the present invention.

### INDUSTRIAL APPLICABILITY

A molded rigid polymer article according to the present invention can be used, for example, as paper substitutes, plastic substitutes, medical devices and/or insulation materials.

### REFERENCE SIGNS LIST

100 Production device
110 Vessel
120 Electrode
122 Electrode
124 Electrode

1. A molded rigid polymer article production method, comprising:
forming a molded rigid polymer article from a rigid-polymer-dispersed liquid, the rigid-polymer-dispersed liquid containing a polar medium and rigid polymers dispersed in the polar medium, the molded rigid polymer article being derived from the rigid polymers deposited on at least one of first and second electrodes; and
drying the molded rigid polymer article, wherein
in the forming, the at least one includes
a surface on which the rigid polymers are deposited, and
convex or concave portions at the surface, the convex or concave portions being larger than a thickness of the molded rigid polymer article.

2. The molded rigid polymer article production method according to claim 1, wherein in the forming, the rigid polymers include a polysaccharide with a straight chain of main chain structure.

3. The molded rigid polymer article production method according to claim 1 or 2, wherein in the forming, field strength at the at least one is 500 V/cm or less.

4. The molded rigid polymer article production method according to claim 1 or 2, wherein in the forming, the at least one includes an insulating base and a conductive film covering a surface of the insulating base.

5. The molded rigid polymer article production method according to claim 4, further comprising dissolving the insulating base.

6. The molded rigid polymer article production method according to claim 4, wherein the forming includes dissolving the conductive film.

7. A molded rigid polymer article containing rigid polymers, comprising:
a first principal surface;
a second principal surface that is a back surface of the first principal surface;
a lateral that connects the first and second principal surfaces, wherein
the first principal surface includes a convex portion greater than a height of the lateral, and
the second principal surface includes a concave portion greater than the height of the lateral.

8. The molded rigid polymer article according to claim 7, wherein the rigid polymers include a polysaccharide with a straight chain of main chain structure.

9. The molded rigid polymer article according to claim 7 or 8, wherein the molded rigid polymer article has a degree of orientation that is 20% or more.

10. The molded rigid polymer article according to claim 7 or 8, wherein the rigid polymers include bio-nanofibers or rigid main chain structures.
